(19) United States
(12) Patent Application Publication
(10) Pub. No.: US 2025/0353441 A1
(43) Pub. Date: Nov. 20, 2025

(54) LOW-PROFILE CROSSBAR CLAMP ASSEMBLY

(71) Applicant: Yakima Products, Inc., Lake Oswego, OR (US)

(72) Inventors: Brandon Michael Willems, Portland, OR (US); Jason Attfield Sagen, Portland, OR (US)

(73) Assignee: Yakima Products, Inc., Lake Oswego, OR (US)

(21) Appl. No.: 19/213,077

(22) Filed: May 20, 2025

Related U.S. Application Data
(60) Provisional application No. 63/649,874, filed on May 20, 2024.

(51) Int. Cl. B60R 9/052; B60R 9/048; E04H 15/06

(52) U.S. Cl. CPC B60R 9/052; B60R 9/048; E04H 15/06

(57) ABSTRACT

A crossbar clamp assembly including first and second jaws, each suspended from and slidable along a rail, a horizontal fastener assembly, and a vertical fastener assembly. The vertical fastener assembly includes a bolt extending through the first jaw with a head portion in a longitudinal slot of the rail. The horizontal fastener assembly extends through a lower portion of each of the first and second jaws, and the assembly is configured to receive a crossbar above the horizontal fastener assembly. Tightening of the vertical fastener assembly secures the first jaw relative to the rail, and tightening of the horizontal fastener assembly draws the first and second jaws together to clamp a received crossbar between the jaws.

### CROSS-REFERENCE TO RELATED APPLICATIONS

This application claims the benefit under 35 U.S.C. § 119(e) of the priority of U.S. Provisional Patent Application Ser. No. 63/649,874, filed May 20, 2024, the entirety of which is hereby incorporated by reference for all purposes.

### BACKGROUND

Rooftop crossbars are often used to secure recreational equipment on a vehicle. For example, a rooftop bike rack or cargo box may be clamped to two or more crossbars. Each crossbar may be supported between two towers secured to the vehicle, and extend laterally across the vehicle, perpendicular to a direction of travel. Crossbars may be used on vehicle rooftops, truck beds, trailers, and/or attached on top of other recreational equipment to allow stacking.

A crossbar clamp may need to resist forces both in the direction of travel and across a vehicle, in addition to supporting the weight of secured equipment. Crossbars also vary in size, cross-sectional shape, and spacing between vehicles. Therefore, a crossbar clamp designed to accommodate a range of bars and having an adjustable position is desirable. For equipment that may be repeatedly installed and removed, position retention for clamps is particularly beneficial.

Rooftop tents are a type of crossbar-secured recreational equipment that is growing in popularity. Rather than transporting a tent in the vehicle interior and then pitching that tent on the ground, campers can transport a rooftop tent clamped to the vehicle's crossbars and then open the tent in place on top of the vehicle.

The bottom platform or footprint of such a tent can render clamps securing the tent to the crossbars difficult to access for installation or adjustment. And any height of the clamps above the crossbars raises the tent also, thereby negatively impacting aerodynamics and fuel efficiency. Low-profile clamps with readily accessible clamping mechanisms are therefore desirable.

### SUMMARY

The present disclosure provides systems, apparatus, and methods relating to crossbar clamps. In some examples, a crossbar clamp assembly may include first and second jaws, each suspended from and slidable along a rail, a horizontal fastener assembly, and a vertical fastener assembly. The vertical fastener assembly may include a bolt extending through the first jaw with a head portion in a longitudinal slot of the rail. The horizontal fastener assembly may extend through a lower portion of each of the first and second jaws, and the assembly may be configured to receive a crossbar above the horizontal fastener assembly. Tightening of the vertical fastener assembly may secure the first jaw relative to the rail, and tightening of the horizontal fastener assembly may draw the first and second jaws together to clamp a received crossbar between the jaws.

In some examples, a clamp assembly for securing recreational equipment to a crossbar may include a rail, first and second jaws, a first fastener assembly, and a second fastener assembly. The rail may be fastened to the recreational equipment, and the jaws may each be suspended from and slidable along a lower portion of the rail. The first fastener assembly may extend through the first jaw into a longitudinal slot of the rail, and the second fastener assembly may extend through lower portions of the first and second jaws. Tightening of the first fastener assembly may secure the first jaw relative to the rail, and tightening of the second fastener assembly may draw the first and second jaws together to clamp a received crossbar between the jaws.

In some examples, a method of securing recreational equipment to a crossbar may include fastening a rail to an underside of the recreational equipment, and lifting the recreational equipment into place on top of the crossbar. The method may further include sliding a first jaw along the rail, into position against the crossbar, and tightening a vertical fastener to secure the first jaw relative to the rail. The method may further include inserting a horizontal fastener under the crossbar, though aligned apertures in the first and second jaws, and tightening the horizontal fastener to draw the second jaw toward the first jaw, thereby clamping the crossbar.

Features, functions, and advantages may be achieved independently in various examples of the present disclosure, or may be combined in yet other examples, further details of which can be seen with reference to the following description and drawings.

### BRIEF DESCRIPTION OF DRAWINGS

FIG. 1 is an isometric view of an illustrative vehicle, including rooftop crossbars.

FIG. 2 is an isometric view of an illustrative rooftop tent assembly secured to the rooftop crossbars of the vehicle of FIG. 1, in a use configuration.

FIG. 3 is an isometric view of an underside of the rooftop tent assembly of FIG. 2, in a storage configuration, including a pair of illustrative low-profile crossbar clamp assemblies in accordance with aspects of the present disclosure.

FIG. 4 is an isometric view of one clamp of the crossbar clamp assemblies of FIG. 3, secured to a section of a crossbar.

FIG. 5 is an isometric detail view from below the rooftop tent assembly of FIG. 2, of the clamp of FIG. 4 in an unsecured and unclamped mode.

FIG. 6 is an isometric detail view from below the rooftop tent assembly of FIG. 2, of the clamp of FIG. 4 in a secured and unclamped mode.

FIG. 7 is a longitudinal cross-sectional view of the clamp of FIG. 4 taken along line A-A, in the unsecured and unclamped mode.

FIG. 8 is a longitudinal cross-sectional view of the crossbar clamp of FIG. 4 taken along line A-A, in the secured and unclamped mode.

FIG. 9 is a longitudinal cross-sectional view of the crossbar clamp of FIG. 4 taken along line A-A, in a secured and clamped mode.

FIG. 10 is a lateral cross-sectional view of the crossbar clamp of FIG. 4 taken along line B-B, in the unsecured mode.

FIG. 11 is a lateral cross-sectional view of the crossbar clamp of FIG. 4 taken along line B-B, in the secured mode.

FIG. 12 is a flow chart depicting steps of an illustrative method of securing a rooftop tent to a vehicle's crossbars, according to the present teachings.

### DETAILED DESCRIPTION

Various aspects and examples of a clamp assembly for securing recreational equipment to a crossbar, as well as related systems and methods, are described below and illustrated in the associated drawings. Unless otherwise specified, a clamp assembly in accordance with the present teachings, and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed examples. The following description of various examples is merely illustrative in nature and is in no way intended to limit the disclosure, its application, or uses. Additionally, the advantages provided by the examples described below are illustrative in nature and not all examples provide the same advantages or the same degree of advantages.

This Detailed Description includes the following sections, which follow immediately below: (1) Definitions; (2) Overview; (3) Examples, Components, and Alternatives; (4) Illustrative Combinations and Additional Examples; (5) Advantages, Features, and Benefits; and (6) Conclusion. The Examples, Components, and Alternatives section is further divided into subsections A and B, each of which is labeled accordingly.

### Definitions

Technical terms used in this disclosure have the meanings that are commonly recognized by those skilled in the art. However, the following terms may have additional meanings, as described below.

Substantially—predominantly conforming to the particular dimension, range, shape, concept, or other aspect modified by the term, such that a feature or component need not conform exactly, so long as it is suitable for its intended purpose or function. For example, a “substantially cylindrical” object means that the object resembles a cylinder, but may have one or more deviations from a true cylinder.

Approximately—when referring to a measurable value such as a parameter, an amount, a temporal duration, and the like, encompasses variations of +/−10% or less, preferably +/−5% or less, more preferably +/−1% or less, and still more preferably +/−0.1% or less of the specified value, insofar as such variations are appropriate to perform in the disclosure. It is to be understood that the value to which the modifier “approximately” refers is itself also specifically, and preferably, disclosed.

Crossbar—an elongate member used as a support, often as part of a pair. Crossbars installed on top of a vehicle such as a car may be referred to as a roof rack, either as a factory-installed component of the vehicle or as after-market equipment installed by a driver. Crossbars may also be used as part of a rack elsewhere on a vehicle, such as a truck rack or bed rack, and/or may be mounted on other transport-related devices such as trailers. Some recreational equipment such as cargo storage may incorporate crossbar elements. Any elongate member configured for and/or having sufficient strength to support cargo or equipment and mounted to or otherwise associated with a means of transport may be encompassed by the term “crossbar” as used herein.

Directional language as used herein should be understood in the context of a reference frame, such as a vehicle. Apparatus and components may be described based on the position thereof relative to the vehicle when mounted on or otherwise connected to the vehicle, even when not currently connected to the vehicle. Such language may include but is not limited to: inboard—directions and/or relative positions closer to a center line of the reference frame; outboard—directions and/or relative positions further from the center line of the reference frame.

The various structural members disclosed herein may be constructed from any suitable material, or combination of materials, such as metal, plastic, nylon, plastic, rubber, or any other materials with sufficient structural strength to withstand the loads incurred during use. Materials may be selected based on their durability, flexibility, weight, and/or aesthetic qualities.

### Overview

In general, a low-profile crossbar clamp assembly may include a rail and two or more clamp devices. Each clamp device may comprise a pair of jaws, including a first jaw and a second jaw, each of which may be configured to slide along the rail. The rail may be configured for fastening to recreational equipment and/or cargo, such as a rooftop tent, cargo box, bike rack, basket, platform, boat rack, camp shower, fishing rod carrier, ski rack, awning, or other such equipment.

The clamp assembly may be used to clamp to any crossbar, including but not limited to vehicle rooftop crossbars, truck bed crossbars, trailer crossbars, and/or crossbars installed on recreational equipment or racks.

In some examples, the rail and/or other components of the assembly may be configured for use with a specific piece of recreational equipment and/or with a specific size or shape of crossbar. For instance, the rail may have an overall length corresponding a specific cargo box model. In some examples, the rail and/or other components of the assembly may be configured for use with a range of recreational equipment and/or a variety of crossbars. For instance, the rail may have an overall length greater than or equal to a standard size of widely available cargo boxes, and the jaws of the clamp devices may have a curved shape appropriate to both round and oval crossbars.

The rail may be configured for fastening to recreational equipment, may be incorporated into a piece of recreational equipment, and/or may be otherwise connected or fixed to recreational equipment. For example, the rail may include at least one aperture in an upper surface to receive some portion of a fastener assembly. For another example, the rail may comprise reinforcing ribs in a bottom wall of a cargo box. For another example, the rail may be welded or adhesively bonded to tray of a bike carrier.

Each clamp device, clamp sub-assembly, or pair of jaws may include at least a first and a second fastener assembly. The first and second fastener assemblies may be independently operable or fastenable. The first fastener assembly may secure the first clamp jaw relative to the rail. The second fastener assembly may secure the crossbar between the first and second jaws.

An upper portion of each jaw may engage the rail, but may not extend above an upper surface of the rail. The jaws may be described as suspended from and/or depending from the rail. In some examples, each jaw may include a bracket or T-shaped structure that extends into a T-slot in the rail. In some examples, each jaw may include a rim or flange along opposing sides of an upper opening, which extends over side projections or shoulder portions of the rail.

In some examples, the first jaw may be connected to the rail by a vertical fastener and first jaw and the second jaw may be connected by a horizontal fastener. For instance, the rail may have a T-slot on an underside and the vertical fastener may be a T-bolt. A head of the T-bolt may be received in the slot of the rail, and the shaft of the bolt may extend through an aperture in the first clamp jaw to engage a nut.

For instance, the horizontal fastener may be a bolt extending through corresponding apertures in lower portions of each jaw to engage a nut. The nut may be prevented from rotating, such that rotating the bolt in a first direction draws the first and second clamp jaws together, and rotating the bolt in a second direction draws the first and second clamp jaws apart. In some such instances, the lower portion of each jaw may be sufficiently spaced from the upper portion to allow a crossbar clamped between the first and second jaws to be received between the rail and the horizontal fastener. That is, when the clamp assembly clamps a crossbar, the rail may extend over the crossbar and the horizontal fastener may extend under the crossbar.

An inner surface of each jaw may be configured to contact a clamped crossbar. For example, the inner surface may be angled and/or curved to impart an upward clamping force. For another example, the inner surface may be shaped to engage a specific crossbar shape and/or range of shapes. For another example, the inner surface may be padded and/or include a grip material to increase contact surface area and improve frictional clamping, and/or avoid damage to the crossbar.

A user may utilize the clamp assembly to clamp equipment on a crossbar by first securing the rail to the equipment. The user may then slide the first and second jaws of each clamp device together along the rail to a location approximately corresponding to an intended position of a crossbar relative to the equipment, leaving the jaws wide enough apart to receive the crossbar. Depending on the size and shape of the equipment, the user use two or more clamp assemblies, similarly securing and preparing each assembly.

The user may lift the equipment into place and/or set the equipment on the crossbars, with the rail of each clamp assembly spanning between at least two crossbars and each point of contact between rail and crossbar being between a first jaw and a second jaw of a clamp device. The user may then slide the first and second jaws of each clamp device into close proximity of the corresponding crossbar.

The first fastener assembly may be used to fix the position of the first jaw. Once a correct position is finalized, the user may subsequently use the second fastener assembly to draw the second jaw toward the first jaw, and close the clamp around the crossbar. In examples where the second fastener assembly includes a fastener extending below the crossbar, such a fastener may be inserted after the equipment is placed onto the crossbars.

Tooling allowing tightening/loosening of the fastener assemblies may be accessible from below the clamp assembly. Preferably, both toolings may be accessible from an outer side of the first clamp jaw. To this end, the location of the first and second jaws may be mirror between clamp devices of a clamp assembly. The fastener assemblies may be configured to allow use of standard tools such as a hex wrench or a screwdriver, and/or manually actuation.

### Examples, Components, and Alternatives

The following sections describe selected aspects of exemplary clamp assemblies as well as related systems and/or methods. The examples in these sections are intended for illustration and should not be interpreted as limiting the entire scope of the present disclosure. Each section may include one or more distinct examples, and/or contextual or related information, function, and/or structure.

### A. Illustrative Rooftop Tent Crossbar Clamp System

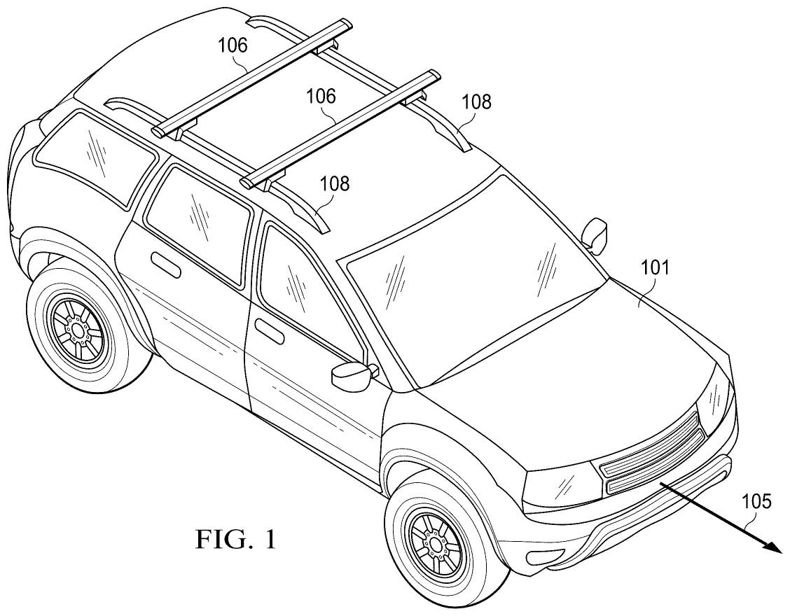

As shown in FIGS. 1-11, this section describes an illustrative rooftop tent assembly 100, including a pair of clamp assemblies 103. Each assembly 103 is an example of a low-profile crossbar clamp assembly, as described above.

FIG. 1 is an isometric view of a vehicle 101, with a rack. In the present example, the vehicle is a four-door sedan car with a roof rack. The car includes a pair of roof rails 108, to which a pair of crossbars 106 have been installed using towers. In some examples the vehicle may be a truck with a bed rack, may be towing a trailer with mounted crossbars, may have a cargo basket on the roof with upper crossbars, and/or may be any useful configuration of vehicle with crossbars.

Vehicle 101 has a direction of travel 105, which may be understood from the vehicle construction even when the vehicle is at rest. The following descriptions may be made with reference to direction of travel of the vehicle, as well as relative positions inboard or outboard in a reference frame of the vehicle.

Crossbars 106 are mounted laterally across the roof of vehicle 101. The crossbars may be described as having a longitudinal extent, which is oriented across the vehicle and/or perpendicular to direction of travel 105. For many users, crossbars 106 may be accessible only at each outboard end, from a position at either side of vehicle 101. In such a position the user of the vehicle roof rack may also be described as accessing crossbars 106 and/or anything secured to the crossbars from below.

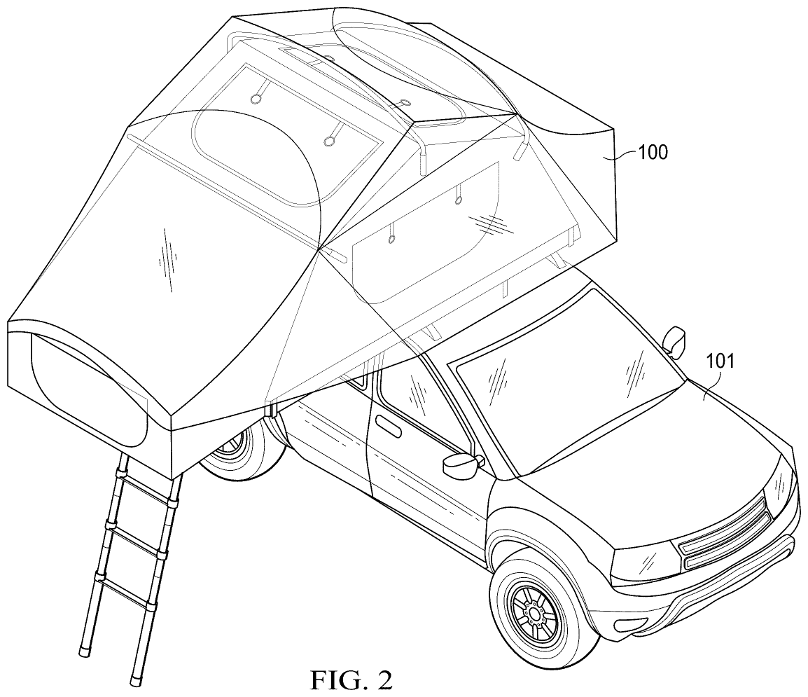

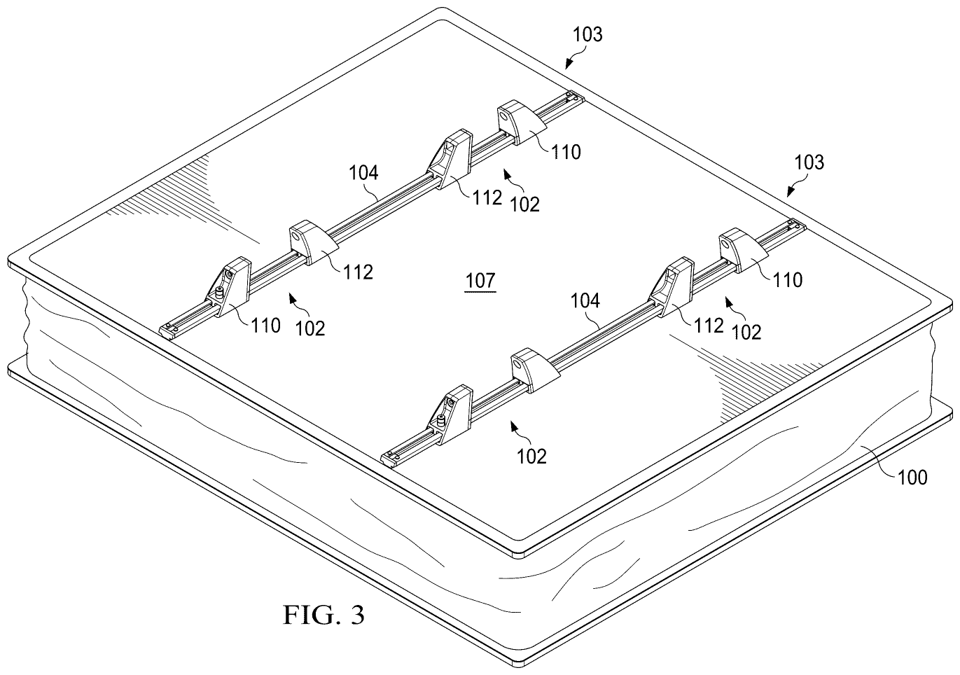

In FIG. 2, vehicle 101 is shown with a rooftop tent system 100 mounted to the roof rack in a deployed configuration. The system is mounted to vehicle 101 by a pair of clamp assemblies as described further below. The tent also has a stowed configuration, shown in FIG. 3. As can be seen in FIG. 2, the tent system obscures an upper side of the roof rack, and securing clamps may only be accessible from below.

The tent system may be described as having a platform structure supporting a tent portion. Overhanging areas of the tent may be partially supported by the ladder, but primary support for the tent and any occupants may be provided by connection to the crossbars of the roof rack by the clamp assemblies. In addition to forces resulting from vehicle motion during transportation of the tent system in the stowed configuration, the clamp assemblies may also need to resist forces related to movement of tent occupants. Forces on the clamp assemblies may therefore be in directions both parallel and perpendicular to the crossbars and/or to the direction of travel of vehicle 101.

FIG. 3 shows tent system 100 upside down in the stowed configuration, with the platform structure uppermost. Fastened to an underside 107 of the platform are the two clamp assemblies 103. Each clamp assembly includes a rail 104, and two clamps 102. The rail may also be referred to as a track and/or extruded bar, and the clamps may also be referred to as clamp device, clamping sub-assembly, and/or crossbar securing sub-assembly.

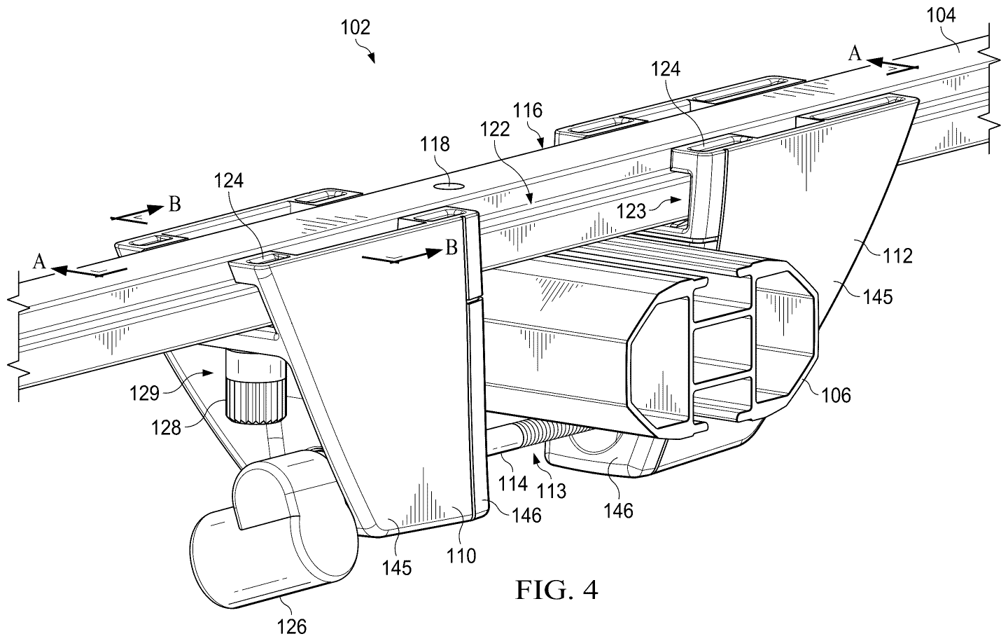

Each clamp includes an outboard jaw 110 and an inboard jaw 112. One of rails 104 and one of clamps 102 are described below and shown in FIGS. 4-11. The four clamps and the two rails may each be substantially similar, and the following description may be understood to apply similarly to all of the clamps and rails.

In some examples, tent assembly 100 may include three or more rails, and each rail may include three, four, or any effective number of clamps. Clamps 102 may be used to secure tent assembly 100 to a vehicle rooftop, truck bed, trailer, and/or any appropriately load bearing crossbars.

FIG. 4 is an isometric view of one of clamps 102, on one of rails 104, secured to one of crossbars 106. Only a section of the crossbar and the rail are depicted, for simplicity. The clamp is actuated by a horizontal fastener assembly 113 and vertical fastener assembly 129. Outboard jaw 110 and inboard jaw 112 of the clamp are connected only via rail 104 and horizontal fastener assembly 113.

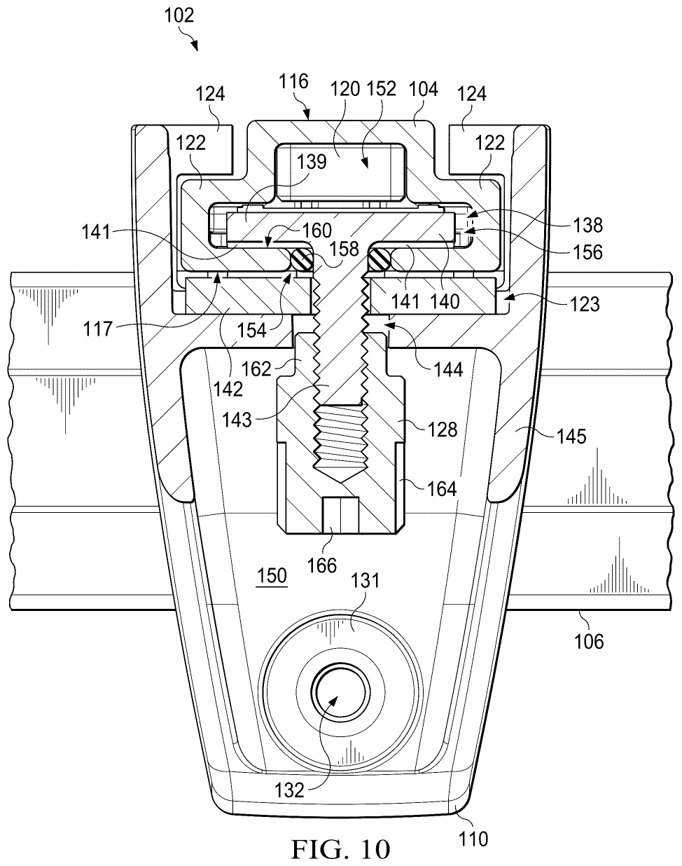

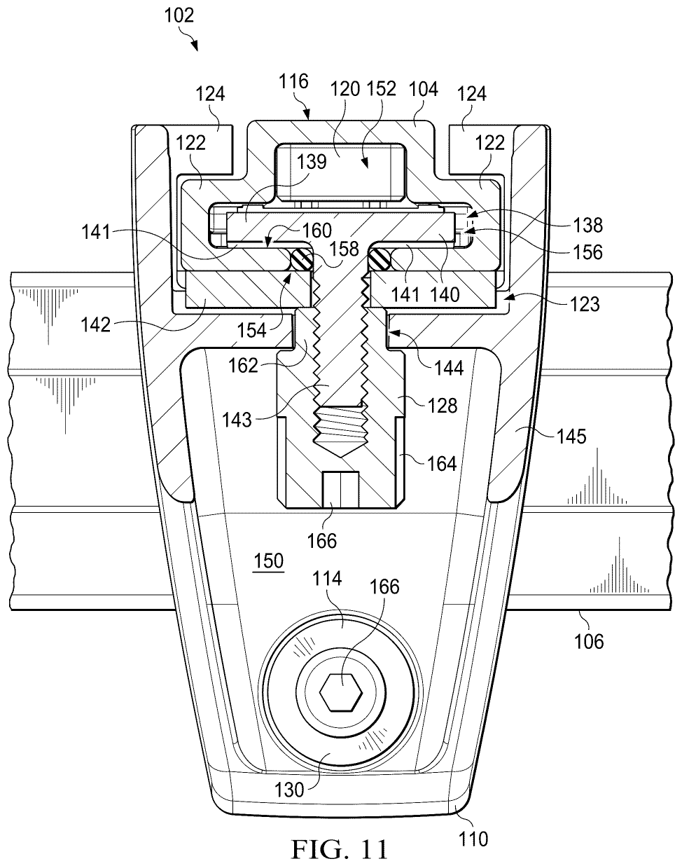

Rail 104 may be described has having a flat top surface, or raised planar upper surface 116. A plurality of holes 118 extend through the flat upper surface. To secure the rail to the rooftop tent, bolts (not shown) extend down through the base of the tent, through holes 118, as described further with reference to FIGS. 10-11, below.

Rail 104 may also be described as having a side recess, wing portion, lower side section, lateral flange, or shoulder 122, extending the length of the rail on each side of the rail. Alternatively, shoulders 122 maybe referred to as a single lower portion of the rail and upper surface 116 may be described as a top wall of an upper portion of the rail.

Outboard jaw 110 and inboard jaw 112 each include a body portion 145 and a grip portion 146. The body portion may be described as comprising an upper portion defining a channel 123 for engaging rail 104, and a lower portion configured for cooperatively engaging crossbar 106. The lower portion has a curved inner side, forming an angled contact surface.

Jaws 110, 112 may also be described as jaw portions, jaw members, cooperative clamping members, and/or side portions of clamp 102, which together define a space for partially enclosing crossbar 106. The defined space may have a decreasing width as the space extends downward from rail 104. Channel 123 of each jaw may be described as opposing u-slots.

The upper portion of each jaw 110, 112 includes a rim or inwardly extending lips or flanges 124 to engage lower shoulders 122 of the rail. Flanges 124 of each jaw are slightly lower than upper surface 116 of rail 104. Upper surface 116 and/or the upper portion of the rail may also be described as proud of jaws 110, 112, and the flanges may be described as defining or restricting an upper opening in channel 123.

In the present example, flanges 124 are uppermost on jaws 110, 112. Flanges 124 or any other uppermost portion of each of the jaws may be sufficiently below upper surface 116 that when clamp assembly 102 is installed on tent assembly 100, jaws 110, 112 do not contact the tent base and therefore remain slidable along rail 104. In general, no part of jaws 110, 112 may protrude upward past upper surface 116 in order that there be no interference between the jaws and equipment secured to the rail.

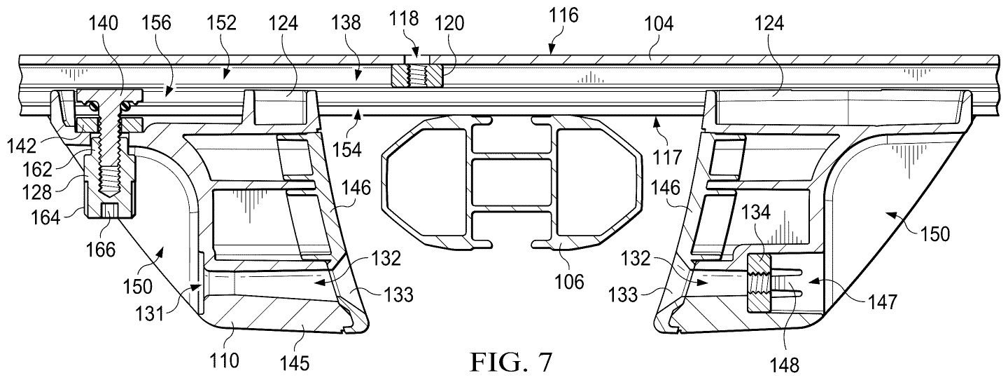

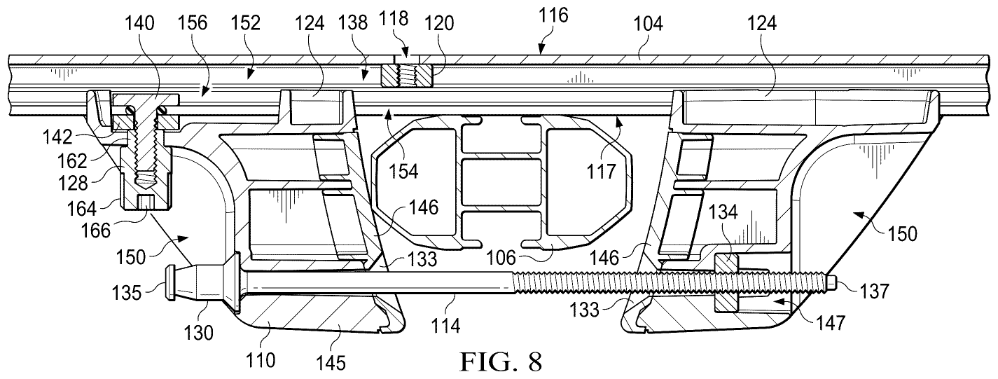

Actuation of clamp 102 via horizontal fastener assembly 113 and vertical fastener assembly 129 is accessible at an outboard or outer side of outboard jaw 110. In the present example, horizontally extending fastener assembly 113 includes a bolt 114 with a head protruding from the outboard jaw. In FIG. 3, the clamp is head of bolt 114 is covered by a lock mechanism 126, which may be installed while the clamp is in use. Also accessible at outboard jaw 110 is a knurled cap nut 128 of vertical fastener assembly 129. The cap nut may be used to tighten or loosen a vertical bolt for securing outboard jaw 110 to rail 104, as discussed further with reference to FIGS. 7-8, below.

As can be seen in FIG. 4, both nut 128 and bolt 114 are accessible from below rail 104. That is, when rail 104 is fastened to tent assembly 100 and clamp 102 is clamped onto crossbar 106, a user may still easily access both actuators. Sufficient clearance is available for the user to either manually turn nut 128 or bolt 114, or use a tool to do so. Indeed, in examples where crossbar 106 is part of a rooftop rack of a vehicle, a user standing beside the vehicle may still have easy access to the actuate the clamp.

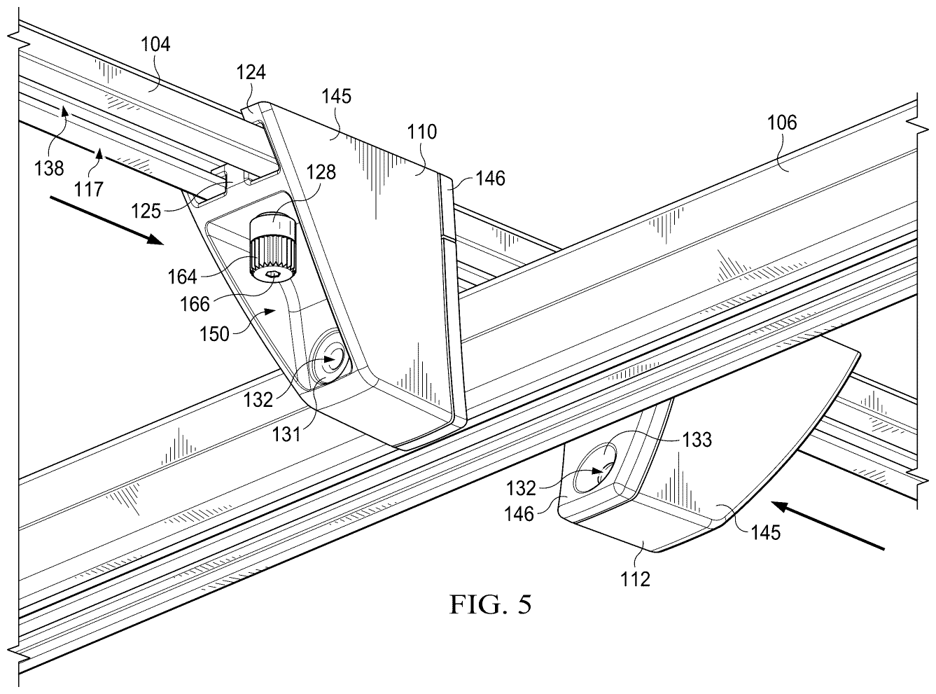

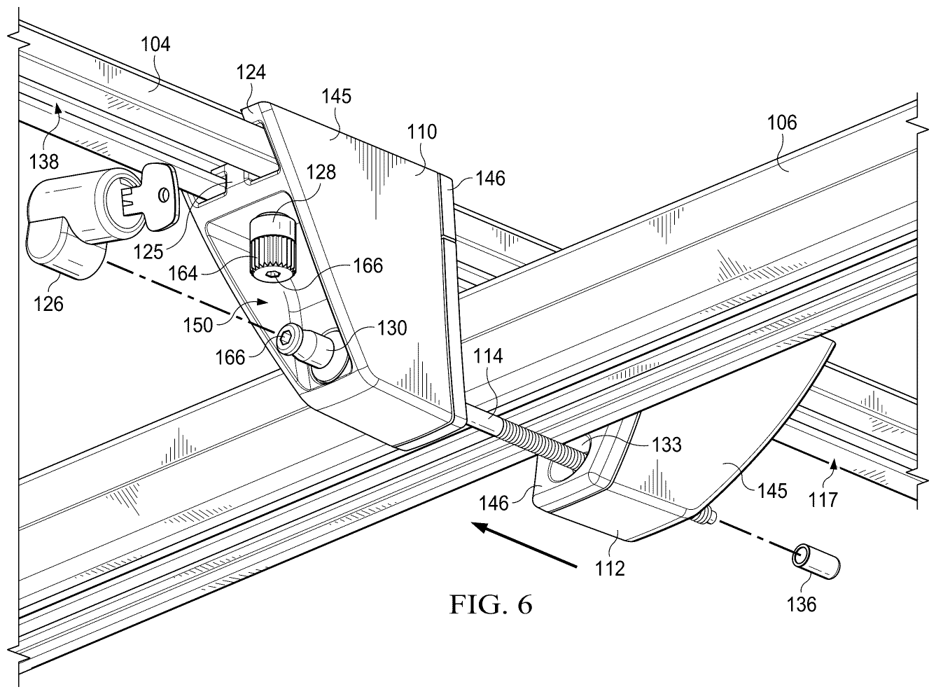

FIGS. 5 and 6 depict clamp 102 in two stages of installation on crossbar 106. In FIG. 5, rail 104 and any attached equipment has been rested on crossbar 106. Jaws 110, 112 are still free to slide on the rail, and a user may slide them into close proximity with the crossbar, as indicated by the arrows. The jaws may be described as suspended from the shoulders of rail 104 by flanges 124, as slidably receiving rail 104 in the channel of the upper portion of each jaw, and/or as slidable along the shoulders of the rail.

In the depicted example, each jaw is suspended by flanges 124 and a central bracket 125 of body portion 145. The central bracket may be described as extending up into channel 123, as subdividing the channel, and/or as engaging a longitudinal slot 138 of rail 104. In the present example, bracket 125 is substantially T-shaped.

Once outboard jaw 110 has been slid into contact with crossbar 106, the user may tighten vertical fastener assembly 129 to fix the outboard jaw in place. Cap nut 128 includes knurling 164 for manual turning and hex tooling 166 for use of a wrench. Rotating the nut may also engage the bolt of the vertical fastener with slot 138 as discussed further below.

The vertical fastener assembly may be described as a pre-clamping device, a set-screw, or a longitudinal clamp. Fixing outboard jaw 110 relative to rail 104 may allow clamp 102 to resist forces perpendicular to crossbar 106, parallel to the direction of travel of the vehicle. For instance, sudden braking of the vehicle in the event of an emergency stop may apply significant forces along the direction of travel. Contact between crossbar 106 and rail 104 may be insufficient to prevent clamp 102 from sliding relative to the rail, resulting in forward movement of a load such as the rooftop tent on top of the vehicle. The vertical fastener assembly may be configured to hold outboard jaw 110 and clamp 102 in place relative to rail 104 even under traffic accident conditions, to ensure road safety.

In FIG. 6, outboard jaw 110 has been fixed in place, and bolt 114 of horizontal fastener assembly 113 has been inserted through both jaws 110, 112. Rotating the bolt may draw inboard jaw 112 toward crossbar 106, as discussed further below. The user may use a hex wrench with tooling 166 to apply appropriate clamping force to crossbar 106 between jaws 110, 112.

Once inboard jaw 112 has been clamped against crossbar 106, lock 126 may be installed over the head of bolt 114 to obstruct access to the bolt and to prevent theft or unwanted interference with the clamp or rooftop tent. Endcap 136 may also be installed on a threaded end of bolt 114 to protect the bolt from damage.

As noted above, both fastener assemblies are accessible from an outer side of outboard jaw 110. More specifically, nut 128 and the head of bolt 114 are disposed in a cavity or cutout 150 of body portion 145 of the outboard jaw. The fastener assemblies are thereby accessible, but protected and discreetly tucked away in the body of the jaw.

FIGS. 7-9 are cross-sectional views of clamp 102 in various modes, taken along line B-B of FIG. 4 in a plane parallel rail 104. Clamp 102 may be described as having a secured mode and an unsecured mode, and as having a clamped mode and an unclamped mode. In FIG. 7, clamp 102 is unsecured and unclamped. In the unsecured mode, T-bolt 140 is not tightened against rail 104 by nut 128, and the bolt can move freely along slot 138. Jaws 110, 112 may therefore also move freely along rail 104, as indicated by the arrows. With bolt 114 installed, the jaws may move together along the rail. With bolt 114 removed, the jaws may move independently relative to the rail.

In FIG. 8 clamp 102 is secured, but unclamped. In the secured mode, T-bolt 140 is tightened against rail 104 by nut 128, as described further with reference to FIGS. 10-11, below. First jaw 110 is thereby fixed relative to rail 104. However, inboard jaw 112 remains able to slide along rail 104. With bolt 114 installed, the bolt may be used to move inboard jaw 112 toward or away from outboard jaw 110, as indicated by the arrows. With bolt 114 removed, inboard jaw 112 may move freely relative to rail 104.

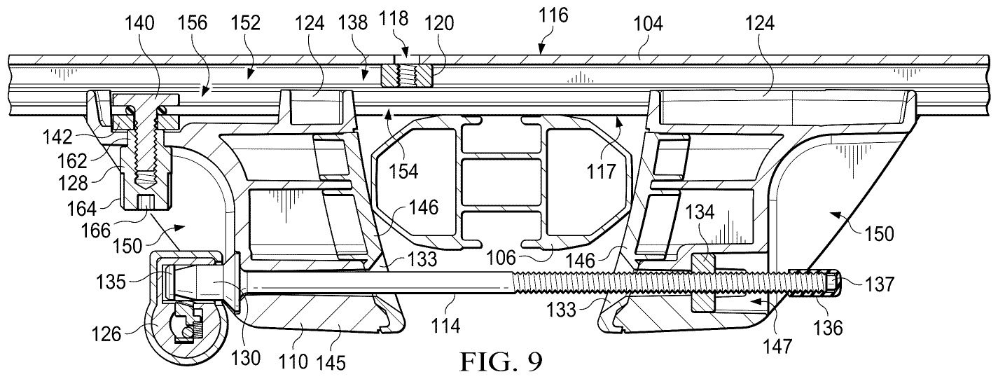

In FIG. 9, clamp 102 is secured, and clamped. Crossbar 106 is received between outboard jaw 110 and inboard jaw 112, and also between rail 104 and bolt 114. Bolt 114 has been tightened to bring jaws 110, 112 into contact with the crossbar on either side, and clamp the crossbar between the jaws.

Outboard jaw 110 and inboard jaw 112 are largely symmetrical, but mirrored. In the present example, body portion 145 of each jaw 110, 112 is comprised of injection molded plastic, and grip portion 146 is comprised of a high-friction, compressible material such as silicone rubber. The grip portion covers a curved inner side of each jaw, opposite cutout 150.

Fastener features and hanger bracket 125 differ between the outboard and inboard jaws. On inboard jaw 112, the hanger bracket extends a full length of the channel of the upper portion. Outboard jaw 110 has two shorter sections of hanger bracket 125 to allow space for a T-bolt 140 of the vertical fastener assembly to engage slot 138.

Slot 138 is open to a lower surface or underside 117 of rail 104. The slot may also be referred to as an internal track, a T-slot, or a channel. In the present example, slot 138 is centered in rail 104. As described further with reference to FIGS. 10 and 11, slot 138 has an upper portion 152, an intermediate space 156, and a restricted opening 154. Hanger bracket 125 of each jaw extends through restricted opening 154 into intermediate space 156.

Bolt 140 extends from intermediate space 156 of slot 138, down through restricted opening 154. A head of the bolt is trapped in intermediate space 156, and the shaft of the bolt extends through a rectangular washer plate 142 immediately below the rail, and a corresponding aperture 144 in outboard jaw 110. Cap nut 128 engages a distal end of bolt 140. An upper boss portion 162 of nut 128 extends up into aperture 144, into proximity with washer plate 142.

Fastener holes 118 in upper surface 116 extend into upper portion 152. A plurality of square nuts 120 are retained in upper portion 152, with one in alignment with each of holes 118.

As shown in FIGS. 8 and 9, when bolt 114 is inserted through jaws 110, 112 a head 130 of the bolt is disposed on the outer side of outboard jaw 110. As shown in FIGS. 5 and 7, outboard jaw 110 includes a shallow annular recess 131 to receive a portion of head 130. Recess 131 may closely conform to head 130 to seat bolt 114 in the correct position. In FIG. 9, head 130 is received in lock 126, which engages a distal flanged portion 135 of the head.

The shaft of bolt 114 extends from head 130 through corresponding, aligned apertures 132 in each of outboard jaw 110 and inboard jaw 112. Aperture 132 of inboard jaw 112 has a tapered entrance 133 formed in grip portion 146 to allow easy insertion of bolt 114 by a user. In the present example, grip portion 146 of outboard jaw 110 may be substantially identical to the grip portion of inboard jaw 112 to allow manufacture of a single piece.

A threaded end portion 137 of the shaft of bolt 114 extends through aperture 132 of inboard jaw 112 into a square cavity 147 to engage a square nut 134. The cavity closely conforms to the nut, such that when threaded end portion 137 rotates, nut 134 cannot rotate in response and instead advances along the threads. Bolt 114 may be described as defining a rotational axis, where rotation of the bolt around the axis causes translation of the inboard jaw along the axis while the outboard jaw remains fixed along the axis.

As shown in FIG. 7, nut 134 is retained in cavity 147 by a snap-fit feature 148. In the present example, feature 148 is a one-way, directionally deformable tab. In general, any effective retention means may be used.

Nut 134 may move along the threads of end portion 137 in a direction corresponding to the direction of rotation of bolt 114. When the bolt is tightened, the nut may advance toward head 130 of the bolt and bear against an inner wall of cavity 147 to move inboard jaw 112 toward outboard jaw 110. When the bolt is loosened, the nut may instead retreat from head 130 and bear against snap-fit feature 148 to move inboard jaw 112 away from outboard jaw 110. That is, rotation of bolt 114 by head 130 may result in urging of inboard jaw 112 toward or away from outboard jaw 110, rather than rotation or axial motion of nut 134.

In the present example, nut 134 is square. In general, the nut may have any shape appropriate to resist rotation, including but not limited to hexagonal, and cavity 147 may be correspondingly shaped.

Grip portions 146 of jaws 110, 112 bear against crossbar 106. The grip portions, or inner contact surfaces, of the jaws are angled such that the jaws apply clamping force to the crossbar at an angle. The force therefore acts laterally inward on the crossbar, but also upward. Crossbar 106 is clamped against underside 117 of rail 104 by jaws 110, 112. Jaws 110, 112, crossbar 106, and rail 104 are therefore all fixed in position relative to one another. No relative motion is permitted, along lateral, transverse, or vertical axes.

Clamp 102 may also be unsecured, but clamped. In such a mode, nut 128 may be loosened to allow T-bolt to slide relative to slot 138. However, outboard jaw 110 may remain fixed relative to rail 104 by contact between crossbar 106 and the rail. Jaws 110, 112 may both be fixed along rail 104 by clamping crossbar 106 between the jaws.

FIGS. 10-11 are cross-sectional views of clamp 102, taken along a plane parallel to crossbar 106. As shown, rail 104 has a generally hat-shaped cross-section. The rail may also be described as having a consistent wall thickness, defining intermediate space 156 and upper portion 152 of slot 138. Received in the upper portion is nut 120.

Flanges 124 of outboard jaw 110 extend over the lower side portions of the rail, retaining the rail in the upper portion of the jaw. Washer 142 is sandwiched between rail 104 and a bottom interior surface of the upper portion of outboard jaw 110. The washer is rectangular, and sized to approximately match a width of rail 104. A central aperture of the washer is aligned with aperture 144 of the outboard jaw.

T-bolt 140 has a flat, rectangular head 139 trapped in slot 138, with a threaded shaft 143 extending down through restricted opening 154. The shape of head 139 may prevent rotation of bolt 140, such that tightening of nut 128 may draw the nut and head 139 toward one another. Shaft 143 of bolt 140 may be described as defining a rotational axis, such that rotation of nut 128 around the axis brings head 139 of the bolt into frictional contact with an inner surface 160 of slot 138.

In the present example, T-bolt 140 includes an o-ring 158 around the bolt immediately below the head, which may help to center the bolt in slot 138 while maintaining ease and tolerance for tightening of nut 128 up into aperture 144 without binding. Also in the present example, the head of the bolt includes two downwardly protruding ridges or linear teeth 141. The bolt may alternatively include texturing on a bottom surface and/or any feature appropriate to frictionally engage inner surface 160 of slot 138. Similarly, washer 142 may include any features appropriate to engage an outer surface of rail 104.

Upper boss portion 162 of nut 128 is sized to be received into aperture 144. As the nut is tightened, the boss portion may draw up through aperture 144 to bear against washer 142, which may in turn press against underside 117 of rail. The rail may therefore be sandwiched between bolt 140 and washer 142, for significant frictional clamping. Below the boss portion, nut 128 increases in diameter such that no more of the nut can be received in aperture 144. Nut 128 may therefore limit tightening and prevent damage to rail 104 by overtightening of bolt 140.

In the present example, a lower portion of nut 128 includes outer knurling 164 for manual tightening of the nut, and inner hex tooling 166 for use of a hex wrench. In some examples, the nut may include exterior tooling for use with a socket wrench and/or any tooling appropriate for easy actuation by a user of clamp 102.

In FIG. 10, clamp 102 is in the unsecured mode. As described above, T-bolt 140 is free to move along slot 138. In FIG. 11, clamp 102 is in the secured mode. Nut 128 is tightened up into contact with washer 142. T-bolt 140 is tightened down into contact with slot 138. Rail 104 is gripped between T-bolt 140 and washer 142.

### B. Illustrative Method

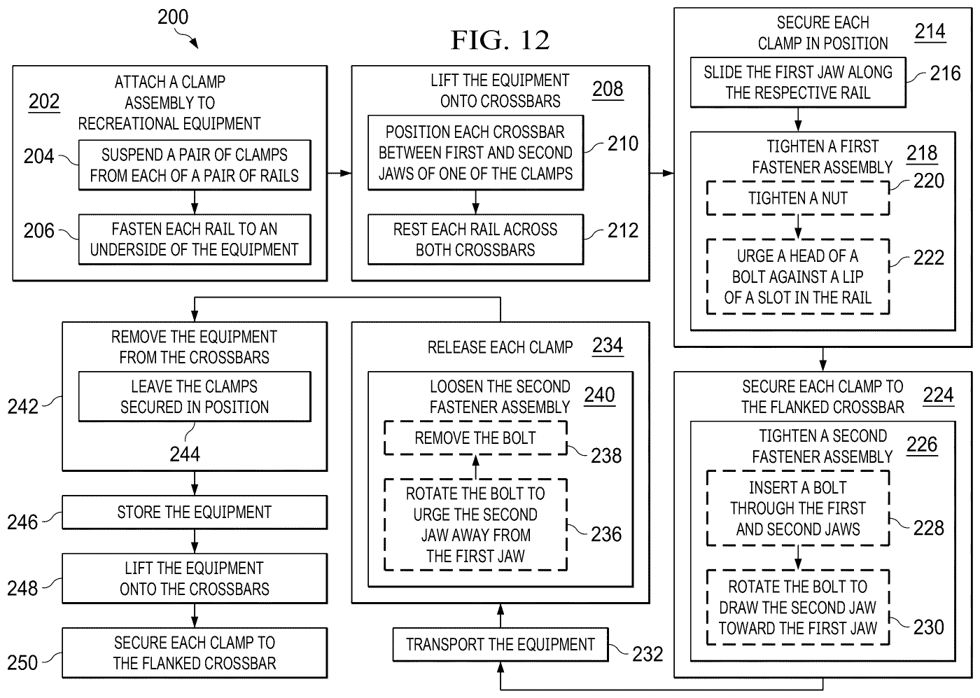

This section describes steps of an illustrative method 200 for securing a rooftop tent to crossbars on a vehicle; see FIG. 12. Aspects of clamp assemblies described above may be utilized in the method steps described below. Where appropriate, reference may be made to components and systems that may be used in carrying out each step. These references are for illustration, and are not intended to limit the possible ways of carrying out any particular step of the method.

FIG. 12 is a flowchart illustrating steps performed in an illustrative method, and may not recite the complete process or all steps of the method. Although various steps of method 200 are described below and depicted in FIG. 12, the steps need not necessarily all be performed, and in some cases may be performed simultaneously or in a different order than the order shown.

At step 202, the method may include attaching a clamp assembly to recreational equipment. Sub-step 204 includes suspending a pair of clamps from each of a pair of rails. For example, a lower shoulder portion of each rail may be slid into a channel of an upper portion of jaws of each clamp. In some examples, the user may install further components such as end-caps onto the rails. Sub-step 206 includes fastening each rail to an underside of the equipment. For example, the user may insert bolts through a platform of a rooftop tent into holes in the rail to engage square nuts housed in the rail.

In some examples, the user may then slide jaws of each clamp along the rail to a location approximately corresponding to the intended position of the crossbar relative to the equipment. The user may remove any horizontal fastener impeding receipt of crossbar, and then slide the clamp jaws wide enough apart to receive the crossbar.

Step 208 includes lifting the equipment onto a pair of crossbars. For example, the user may request assistance to lift the rooftop tent onto crossbars of a roof rack of their vehicle. Sub-steps 210-212 may be performed as the equipment is lowered into place and/or set on the crossbars. The rooftop tent with attached clamp assemblies may be placed with each crossbar between first and second jaws of one of the clamps, and each rail resting across both crossbars.

At step 214, method 200 includes securing each clamp in position, or positioning the clamp and transitioning the clamp to a secured mode or configuration. This securing step may fix the clamp against longitudinal motion, that is motion parallel the rail, perpendicular to the crossbar, and/or parallel a direction of travel of the vehicle.

Sub-steps 216-222 may be repeated for each clamp. Sub-step 216 includes sliding the first jaw along the rail. In some examples, sliding the first jaw may include sliding the rail in a channel of the jaw, sliding a flange of the jaw along a shoulder of the rail, sliding the jaw along a flange of the rail, and/or siding a bracket of the jaw along a T-slot of the rail.

Sub-step 218 includes tightening a first fastener assembly. In some examples, the first fastener assembly may include a vertically extending bolt and a nut. For such examples, sub-steps 220-222 may be used.

Sub-step 220 includes tightening a nut. The nut may be accessed at an outer or outboard side of the first jaw, and may be tightened by hand and/or by use of a tool. The nut may be rotated around a rotational axis defined by the bolt, where the axis Is perpendicular to a long axis of the rail. The vertically extending bolt may be prevented from rotating, for instance by contact of a square head in a linear slot of the rail. Tightening the nut may therefore force the bolt head into frictional contact with an inner surface of the slot of the rail, as in sub-step 222.

Additional elements of the first fastener assembly may facilitate these steps. For instance, the assembly may include a washer to increase frictional contact with the rail and/or a deformable ring around a shaft of the bolt to center the assembly without binding.

In examples with different fastener assemblies, sub-step 218 may be accomplished according to the specifics of that assembly. In such examples, tightening the first fastener assembly may include bringing at least one faster into frictional contact with the rail by rotating that fastener or another engaged fastener.

At step 224, the method includes securing each clamp to the flanked crossbar, clamping the jaws of the clamp around the crossbar, and/or transitioning the clamp to a clamped mode. This securing step may fix the clamp against lateral motion, that is motion perpendicular to the rail, parallel the crossbar, and/or perpendicular to a direction of travel of the vehicle. Sub-steps 226-230 may be repeated for each clamp.

Sub-step 226 includes tightening a second fastener assembly. In some examples, the second fastener assembly may include a bolt extending horizontally under the crossbar from the first jaw to the second jaw, and a nut in the second jaw. For such examples, sub-steps 228-230 may be used.

Sub-step 228 includes inserting a bolt through the first and second jaws. The bolt may be kept aside until step 228, in order that the bolt not impede receipt of the crossbar between the first and second jaws of the clamp. With the crossbar in place, the bolt may be inserted through aligned apertures in the jaws, under the crossbar, with the head of the bolt accessible at the same outer side of the first jaw as the nut of the first fastener assembly.

Sub-step 230 includes rotating the horizontal bolt to draw the second jaw toward the first jaw. The bolt may extend parallel to the rail, between the jaws. The bolt may also be described as defining a horizontal rotational axis parallel to the rail.

The bolt may be threadingly engaged with a nut member trapped in the second jaw. For instance, the nut may trapped by a deformable tab or snap-fit feature. The nut may shaped to prevent rotation by contact with the second jaw, such that rotation of the bolt draws the nut up the threads and pulls the second jaw along the rail toward the first jaw. The step may be described as closing the jaws around the crossbar.

In examples with different fastener assemblies, sub-step 226 may be accomplished according to the specifics of that assembly. In such examples, tightening the second fastener assembly may include driving one of the jaws toward the other to clamp the rail to the crossbar. The driven jaw may slide along the rail as in step 210.

Tooling allowing tightening/loosening of the first and second fastener assemblies may be accessible from below each clamp. Preferably, both toolings may be accessible from an outer side of the first clamp jaw. The location of the fasteners, as well as the position of the tooling may allow a user to easily access and clamp, un-clamp, or adjust the clamp assembly while the rail is secured to equipment and the clamp is on a crossbar. The user may be able to use standard tools such as a hex wrench or a screwdriver, and/or manually actuate one or both of the fasteners.

At step 232, the method includes transporting the equipment. For instance, using the vehicle while the rooftop tent or other equipment is secured to the roof rack crossbars. In some examples, a user may also use the equipment in some manner without detaching the equipment from the roof rack. For instance, the user may deploy the tent for the night. For another instance, the user may open a secure cargo box to access stored cargo.

To temporarily remove the equipment from the crossbars, and then reinstall the equipment, the user may proceed with steps 234-250. To remove the equipment on a permanent basis, the user may with may follow just steps 234-242.

At step 234, the method includes releasing each clamp. The step may be described as reversing steps 224-230. Specifically, sub-step 240 includes loosening the second fastener assembly. Similarly to sub-step 226, sub-step 240 may be performed according to the specific fastener assembly. For the above-described horizontal fastener assembly, sub-steps 236 and 238 include rotating the bolt to urge the second jaw away from the first jaw and removing the bot. The jaws may thereby release the crossbar and leave a clear path for the crossbar to be removed from between the jaws.

In some examples, the horizontal fastener may be configured to remain installed in the first and second clamp jaws. In such examples, a free end of a crossbar may be inserted between the fastener and the rail, or some other element may be moved and/or removed to allow the crossbar to be received between the fastener and the rail.

Step 242 includes removing the equipment from the crossbars. For instance, the user may lift the rooftop tent off of the roof rack. As in sub-step 244, the vertical fastener may be left engaged, to simplify reinstallation. That is, the first fastener assembly may not be loosened, or any clamp transition to an unsecured mode. More specifically, the first clamp jaw may remain in the correct position, so that the equipment can simply be placed on the crossbar and the clamp re-engaged without need to repeat the process of correctly positioning the clamp and/or equipment relative to the crossbar.

Step 246 includes storing the equipment. For instance, a user may store a rooftop tent in a garage or other storage location, with each clamp still secured in position. Step 248 may be performed similarly to step 208, and step 250 may be performed similarly to step 250. That is, the user may reinstall the equipment on the crossbars in the same manner as the equipment was originally installed, but without the need to perform steps 202-206 or 214-222 again.

### Illustrative Combinations and Additional Examples

This section describes additional aspects and features of clamp assemblies, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A recreational equipment crossbar clamp, comprising:
a rail including a longitudinal slot;
first and second clamp jaws, each slidable along the rail;
a vertical fastener having a head portion in the longitudinal slot of the rail, and extending through an aperture in the first clamp jaw; and
a horizontal fastener, extending through corresponding apertures in lower portions of the first and second clamp jaws, wherein the clamp is configured to receive a crossbar above the horizontal fastener;
wherein tightening of the vertical fastener secures the first clamp jaw relative to the rail, and tightening of the horizontal fastener draws together the first and second clamp jaws to clamp a crossbar between the jaws.

A1. The clamp of paragraph A0, wherein each jaw includes an angled contact surface, such that clamping a crossbar between the jaws also clamps the crossbar against a lower surface of the rail.

A2. The clamp of paragraph A1, wherein clamping the crossbar between the jaws of the clamp and against the lower surface of the rail fixes a position of the crossbar both laterally and longitudinally relative to the rail.

A3. The clamp of paragraph A0 or A1, wherein each jaw includes an upper slot to receive the rail.

A4. The clamp of any of paragraphs A0-A3, wherein the longitudinal slot of the rail is a T-slot and the vertical fastener is a T-bolt.

A5. The clamp of paragraph A4, wherein a threaded end of the T-bolt is received in a nut with hex wrench tooling.

A6. The clamp of paragraph A5, wherein the nut is accessible from below the clamp.

A7. The clamp of any of paragraphs A0-A6, further including a rectangular washer plate sandwiched between the rail and the first clamp jaw, the vertical extending fastener extending through the washer plate.

A8. The clamp of any of paragraphs A0-A7, wherein the horizontal fastener has a head portion on an outer side of the first jaw and engages a rectangular nut on an outer side of the second clamp jaw.

A9. The clamp of any of paragraphs A0-A8, further including a lock covering the head portion of the horizontal fastener.

A10. The clamp of any of paragraphs A0-A9, wherein the rail includes a plurality of apertures configured for fastening the rail to recreational equipment.

A11. The clamp of paragraph A10, wherein an upper surface of the rail stands proud of each of the first and second clamp jaws.

A12. The clamp of any of paragraphs A0-A11, wherein the horizontal fastener is accessible from below the clamp.

B0. A method of securing recreational equipment to a crossbar, comprising:
fastening a rail to an underside of the recreational equipment;
sliding first and second clamp jaws along the rail to an approximate position;
lifting the recreational equipment into place on top of the crossbar;
sliding the first clamp jaw into position against the crossbar;
tightening a vertical fastener to secure the first clamp jaw relative to the rail;
inserting a horizontal fastener under the crossbar, through aligned apertures in the first and second clamp jaws; and
tightening the horizontal fastener to draw the second clamp toward the first clamp, thereby clamping the crossbar.

B1. The method of paragraph B0, further including removing and storing the recreational equipment, by:
loosening the horizontal fastener to unclamp the crossbar;
removing the horizontal fastener; and
leaving the first clamp jaw secured relative to the rail.

B2. The method of paragraph B1, further including reinstalling the stored recreational equipment, by:
leaving the first clamp jaw secured relative to the rail;
lifting the recreational equipment into place on top of the crossbar;
tightening a vertical fastener to secure the first clamp jaw relative to the rail;
inserting the horizontal fastener under the crossbar, through the aligned apertures in the first and second clamp jaws;
tightening the horizontal fastener to draw the second clamp toward the first clamp, thereby clamping the crossbar.

C0. A rooftop tent, comprising:
a base platform;
a stowable tent portion fixed an upper side of the base platform;
a pair of rails fixed to a lower side of the base platform;
at least one crossbar clamp on each of the pair of rails, each clamp including:
first and second clamp jaws, each slidable along the rail; and
a horizontal fastener, extending through corresponding apertures in lower portions of the first and second clamp jaws, wherein the clamp is configured to receive a crossbar above the horizontal fastener.

C1. The rooftop tent of paragraph C0, wherein each clamp further includes a vertical fastener extending through an aperture in the first clamp jaw to engage the respective rail.

C2. The rooftop tent of paragraph C1, wherein tightening of the vertical fastener secures the first clamp jaw relative to the rail, and tightening of the horizontal fastener draws together the first and second clamp jaws to clamp a crossbar.

D0. A crossbar clamp assembly, comprising:
a rail including a longitudinal slot;
first and second clamp jaws, each suspended from and slidable along the rail;
a vertical fastener assembly including a bolt having a head portion in the longitudinal slot of the rail and extending through the first clamp jaw; and
a horizontal fastener assembly, extending through a lower portion of each of the first and second clamp jaws, wherein the crossbar clamp assembly is configured to receive a crossbar above the horizontal fastener assembly;
wherein tightening of the vertical fastener assembly secures the first clamp jaw relative to the rail, and tightening of the horizontal fastener assembly draws together the first and second clamp jaws to clamp a received crossbar between the clamp jaws.

D1. The crossbar clamp assembly of paragraph D0, wherein tightening the vertical and horizontal fastener assemblies fixes a position of the crossbar both laterally and longitudinally relative to the rail.

D2. The crossbar clamp assembly of paragraph D0 or D1, wherein the vertical fastener assembly is accessible at an outer side of the first clamp jaw.

D3. The crossbar clamp assembly of paragraph D2, wherein the horizontal fastener assembly is accessible at the outer side of the first clamp jaw.

D4. The crossbar clamp assembly of any of paragraphs D0-D3, wherein each jaw includes an upper T-slot to receive a lower portion of the rail.

D5. The crossbar clamp assembly of any of paragraphs D0-D4, wherein the longitudinal slot of the rail is a T-slot and the vertical fastener assembly includes a T-bolt.

D6. The crossbar clamp assembly of paragraph D5, wherein the vertical fastener assembly further includes a nut engaging a threaded end of the T-bolt.

D7. The crossbar clamp assembly of paragraph D6, wherein the nut is disposed on an outer side of the first clamp jaw.

D8. The crossbar clamp assembly of paragraph D6 or D7, wherein the vertical fastener assembly further includes a rectangular washer plate sandwiched between the rail and the first clamp jaw, the T-bolt extending through the washer plate.

D9. The crossbar clamp assembly of any of paragraphs D0-D8, wherein the horizontal fastener assembly includes a bolt having a head portion on an outer side of the first clamp jaw and a rectangular nut on an outer side of the second clamp jaw.

D10. The crossbar clamp assembly of paragraph D9, further including a lock covering the head portion of the bolt.

D11. The crossbar clamp assembly of any of paragraphs D0-D10, wherein an upper surface of the rail includes a plurality of apertures configured for fastening the rail to recreational equipment.

D12. The crossbar clamp assembly of paragraph D11, wherein the upper surface of the rail stands proud of each of the first and second clamp jaws.

D13. The crossbar clamp assembly of any of paragraphs D0-D12, wherein each clamp jaw includes an angled contact surface, such that clamping a crossbar between the clamp jaws also clamps the crossbar against a lower surface of the rail.

E0. A clamp assembly for securing recreational equipment to a crossbar, comprising:
a rail fastened to the recreational equipment and including a longitudinal slot;
first and second clamp jaws, each suspended from and slidable along a lower portion of the rail;
a first fastener assembly extending through the first clamp jaw into the longitudinal slot of the rail; and
a second fastener assembly, extending through lower portions of the first and second clamp jaws;
wherein tightening of the first fastener assembly secures the first clamp jaw relative to the rail, and tightening of the second fastener assembly draws together the first and second clamp jaws to clamp a crossbar between the clamp jaws.

E1. The clamp assembly of paragraph E0, wherein the longitudinal slot is a central T-slot disposed in a lower surface of the rail.

E2. The clamp assembly of paragraph E0 or E1, wherein the rail has a flat upper surface in contact with an underside of the recreational equipment, and an uppermost portion of each of the first and second clamp jaws is below the flat upper surface.

E3. The clamp assembly of any of paragraphs E0-E2, wherein the first and second fastener assemblies are each accessible from below and at one side of the clamp assembly.

F0. An apparatus for connecting cargo to a crossbar mounted on top of a vehicle, comprising
a rail having a longitudinal T-slot, and a pair of lateral flanges on opposite sides of the slot,
a first jaw member and a second jaw member, each jaw member having opposing U-slots for receiving and sliding along the lateral flanges of the rail,
a first bolt having a threaded shaft defining a first rotational axis perpendicular to the long axis of the rail, a head on a proximal end portion of the shaft, and a nut member on a distal end portion of the shaft, the head being slidably engaged in the T-slot of the rail, wherein rotation of the nut member around the first rotational axis causes fixation of the head to a selected horizontal location in the T-slot, and
a second bolt defining a second rotational axis parallel to the long axis of the rail, connecting the first and second jaw members, and operable to move at least one of the jaw members relative to the other jaw member, between a clamped position and an unclamped position relative to a crossbar.

F1. The apparatus of paragraph F0, wherein the second bolt connects the jaw members below the crossbar.

F2. The apparatus of paragraph F0 or F1, wherein the jaw members define a space for partially enclosing the crossbar, the space having a decreasing width, extending distally from the rail.

F3. The apparatus of any of paragraphs F0-F2, wherein rotation of the first bolt around the first rotational axis brings the head into frictional contact with an inner surface of the T-slot.

F4. The apparatus of paragraph F3, wherein the head of the first bolt has one or more projections for frictionally engaging the inner surface of the T-slot.

F5. The apparatus of any of paragraphs F0-F4, wherein rotation of the second bolt around the second rotational axis causes translation of the second jaw member along the second rotational axis while the first jaw member remains fixed along the second rotational axis.

F6. The apparatus of any of paragraphs F0-F5, wherein the first bolt sets location of the first jaw member adjacent intersection of the rail and a crossbar prior to actuating the jaw members to clamp a crossbar.

G0. An assembly for connecting cargo to a crossbar mounted on top of a vehicle, comprising
a rail having a track,
a first jaw member and a second jaw member, the jaw members being slidable along the track of the rail,
a horizontal bolt defining a horizontal rotational axis parallel to the long axis of the rail, connecting the first and second jaw members, and operable to move at least one of the jaw members relative to the other jaw member, between a clamped position and an unclamped position relative to a crossbar, and
a pre-clamping device, operable to set the horizontal location of the first jaw member prior to actuating the jaw members to the clamped position.

G1. The assembly of paragraph G0, wherein the rail has a T-slot, the pre-clamping device is operable to frictionally engage a wall of the T-slot.

H0. A method of securing cargo on a pair of crossbars, comprising
positioning a first jaw member, along a rail, into contact with a crossbar, the rail running perpendicular to the crossbar,
locking location of the first jaw member along the rail by rotating a bolt around a rotational axis perpendicular to the long axis of the rail, and
driving a second jaw member toward the first jaw member to clamp the rail to the crossbar.

H1. The method of paragraph H0, wherein the locking step includes forcing a bolt head into frictional contact with an inner surface of a T-slot in the rail.

H2. The method of paragraph H0 or H1, wherein the rail has a pair of flanges, the positioning step including sliding the first jaw member along the flanges of the rail.

H3. The method of paragraph H2, wherein the driving step includes sliding the second jaw member along the flanges of the rail toward the first jaw member.

### Advantages, Features, and Benefits

The different examples of the clamp assembly described herein provide several advantages over known solutions for securing equipment or cargo to a set of crossbars. For example, illustrative examples described herein secure the equipment or cargo in directions both parallel to and perpendicular to the extent of the crossbars.

Additionally, and among other benefits, illustrative examples described herein allow a user to access all fasteners from below and to one side, as is convenient when standing at one side of a vehicle with crossbars.

Additionally, and among other benefits, illustrative examples described herein allow a user to adjust a position of each clamp of the assembly, to fit a variety of crossbar spacings.

Additionally, and among other benefits, illustrative examples described herein allow a user to set the position of each clamp of the assembly while the clamps are disengaged from any crossbar, such that the positions subsequently need not be re-adjusted each time the equipment or cargo is secured to the crossbars.

No known system or device can perform these functions, particularly in low-profile form. Thus, the illustrative examples described herein are particularly useful for mounting rooftop tents to a vehicle. However, not all examples described herein provide the same advantages or the same degree of advantage.

### CONCLUSION

The disclosure set forth above may encompass multiple distinct examples with independent utility. Although each of these has been disclosed in its preferred form(s), the specific examples thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A crossbar clamp assembly, comprising:
a rail including a longitudinal slot;
first and second jaws, each suspended from and slidable along the rail;
a vertical fastener assembly including a bolt having a head portion in the longitudinal slot of the rail and extending through the first jaw; and
a horizontal fastener assembly, extending through a lower portion of each of the first and second jaws, wherein the crossbar clamp assembly is configured to receive a crossbar above the horizontal fastener assembly;
wherein tightening of the vertical fastener assembly secures the first jaw relative to the rail, and tightening of the horizontal fastener assembly draws together the first and second jaws to clamp a received crossbar between the jaws.

2. The crossbar clamp assembly of claim 1, wherein tightening the vertical and horizontal fastener assemblies fixes a position of the crossbar both laterally and longitudinally relative to the rail.

3. The crossbar clamp assembly of claim 1, wherein the vertical fastener assembly is accessible at an outer side of the first jaw.

4. The crossbar clamp assembly of claim 3, wherein the horizontal fastener assembly is accessible at the outer side of the first jaw.

5. The crossbar clamp assembly of claim 1, wherein each jaw includes an upper T-slot to receive a lower portion of the rail.

6. The crossbar clamp assembly of claim 1, wherein the longitudinal slot of the rail is a T-slot and the vertical fastener assembly includes a T-bolt.

7. The crossbar clamp assembly of claim 6, wherein the vertical fastener assembly further includes a nut engaging a threaded end of the T-bolt.

8. The crossbar clamp assembly of claim 7, wherein the nut is disposed on an outer side of the first jaw.

9. The crossbar clamp assembly of claim 7, wherein the vertical fastener assembly further includes a rectangular washer plate sandwiched between the rail and the first jaw, the T-bolt extending through the washer plate.

10. The crossbar clamp assembly of claim 1, wherein the horizontal fastener assembly includes a bolt having a head portion on an outer side of the first jaw and a rectangular nut on an outer side of the second jaw.

11. The crossbar clamp assembly of claim 10, further including a lock covering the head portion of the bolt.

12. The crossbar clamp assembly of claim 1, wherein an upper surface of the rail includes a plurality of apertures configured for fastening the rail to recreational equipment.

13. The crossbar clamp assembly of claim 12, wherein the upper surface of the rail stands proud of each of the first and second jaws.

14. The crossbar clamp assembly of claim 1, wherein each jaw includes an angled contact surface, such that clamping a crossbar between the jaws also clamps the crossbar against a lower surface of the rail.

15. A clamp assembly for securing recreational equipment to a crossbar, comprising:
a rail fastened to the recreational equipment and including a longitudinal slot;
first and second jaws, each suspended from and slidable along a lower portion of the rail;
a first fastener assembly extending through the first jaw into the longitudinal slot of the rail; and
a second fastener assembly, extending through lower portions of the first and second jaws;
wherein tightening of the first fastener assembly secures the first jaw relative to the rail, and tightening of the second fastener assembly draws together the first and second jaws to clamp a crossbar between the jaws.

16. The clamp assembly of claim 15, wherein the longitudinal slot is a central T-slot disposed in a lower surface of the rail.

17. The clamp assembly of claim 15, wherein the rail has a flat upper surface in contact with an underside of the recreational equipment, and an uppermost portion of each of the first and second jaws is below the flat upper surface.

18. The clamp assembly of claim 15, wherein the first and second fastener assemblies are each accessible from below and at one side of the clamp assembly.

19. A method of securing recreational equipment to a crossbar, comprising:
fastening a rail to an underside of the recreational equipment;
lifting the recreational equipment into place on top of the crossbar;
sliding a first jaw along the rail, into position against the crossbar;
tightening a vertical fastener to secure the first jaw relative to the rail;
inserting a horizontal fastener under the crossbar, through aligned apertures in the first jaw and a second jaw; and
tightening the horizontal fastener to draw the second jaw toward the first jaw, thereby clamping the crossbar.

20. The method of claim 19, further including:
loosening the horizontal fastener to unclamp the crossbar;
removing the horizontal fastener;
removing the recreational equipment from the crossbar;
leaving the first jaw secured relative to the rail; and
storing the recreational equipment.
